(19) United States
(12) Patent Application Publication
(10) Pub. No.: US 2007/0188280 A1
(43) Pub. Date: Aug. 16, 2007

(54) Superconductive coil assembly having improved cooling efficiency

(76) Inventors: Heui-Joo Park, Gyeongsangnam-do (KR); Yeong-Chun Kim, Gyeongsangnam-do (KR); Tae-Sun Moon, Busan (KR); Woon-Sik Kwon, Gyeongsangnam-do (KR)

Correspondence Address: DICKSTEIN SHAPIRO LLP, 1825 EYE STREET NW, Washington, DC, 20006-5403, US

(21) Appl. No.: 11/357,983

(22) Filed: Feb. 22, 2006

(30) Foreign Application Priority Data
Feb. 13, 2006 (KR) 10-2006-0013529

(51) Int. Cl. H01F 6/00

(52) U.S. Cl. 335/216

(57) ABSTRACT

A superconductive coil assembly has a bobbin, a coil provided such that a superconductive wire is wound several times around the bobbin, and a pair of heat transfer plates installed to cover the opposite sides of the bobbin and the coil. The heat transfer plate is made of metal material with high thermal conductivity, such as copper or aluminum, and a portion thereof abutted upon the side of the coil is coated with electric insulating material. If adapted to a generator, an electric motor, and so on, the plurality of superconductive coil assemblies is used while being overlapped. In this case, a connection recess is provided to at least one heat transfer plate to enable a portion of the side of the coil to be exposed outside, in order for electrical connection with another superconductive coil assembly. By the construction of the superconductive coil assembly, a heat transfer path between the cooling source and the superconductive coil is diversified by the heat transfer plate, thereby shortening a cooling time of the superconductive coil as well as improving cryogenic operation stability. Further, the heat transfer plate protects the side of the superconductive coil so that even when the superconductive coil is applied to the inside of the rotor of a generator or an electric motor, and operates under the centrifugal force, it can operate stably and continuously.

### CROSS-REFERENCE TO RELATED APPLICATION

This application claims all benefits of Korean Patent Application No. 10-2006-13529, filed on Feb. 13, 2006 in the Korean Intellectual Property Office, the disclosures of which is incorporated herein by reference.

### BACKGROUND OF THE INVENTION

1. Field of the Invention

The present invention relates to a superconductive coil assembly used in a superconducting generator or electric motor, and more particularly to a superconductive coil assembly having improved cooling efficiency through the modification of a heat transfer path between a coil and a cooling source.

2. Description of the Prior Art

Generally, superconductive coils are the coils which have superconductivity at very low temperature below approximately −196° C., and are mainly used in high current flow and magnetic field appliances using a superconducting characteristic in the cryogenic environment.

Such superconductive coil requires that the cryogenic cooling performance thereof should be improved for the stable maintenance of superconducting state, and the avoidance of fault characteristics such as a coil quench.

As for the cryogenic cooling method of the superconductive coil, there are two cooling methods of the superconductive coil, one of which is a direct cooling method that brings the coil into direct contact with gaseous coolants such as helium or neon, or liquid coolants such as liquid nitrogen, thereby directly cooling the coil, and the other of which is a conduction cooling method that brings the coil into contact with the cooling source, such as evaporators, to cause heat of the coil to be conducted to the cooling source, thereby indirectly cooling the coil. Because the direct cooling method may cause corrosion to the coil by the direct contact of the coil with the coolants, the conduction cooling method is generally used.

In a superconducting generator or electric motor, a superconductive coil is installed in a rotor so it operates under a centrifugal force. In order for the maintenance of stable and continuous operation of the superconductive coil, it requires that the cooling performance and structural strength of the superconductive coil should be improved.

A conventional superconductive coil assembly includes a bobbin and a coil provided such that a wire rectangular in cross-section is wound several times around the bobbin. A glass fiber reinforced plastic (GFRP) sheet is bonded to opposite sides of the coil by low temperature epoxy so as to electrically insulate and to prevent the damage by centrifugal force.

Such conventional coil assembly has advantage in structural reinforcement, but also has a problem in that because of low heat conductivity in character of GFRP sheet, if several coil assemblies are used while being overlapped to each other, the heat transfer between coils is not smoothly implemented so it takes so many time to cool them. Further, if a single coil assembly unit is used, upon conduction cooling, the heat transfer path between the cooling source and the coil horizontally extends at full length from the bobbin to the outside of the coil through the inside of the coil, so that it causes a problem in that it takes so many time to cool the coil as well as there is generated a temperature gradient between the inside and outside of the coil. If the temperature gradient there between is large, the coil may be quenched at its outside, being damaged.

### SUMMARY OF THE INVENTION

Accordingly, the present invention has been made to solve the above-mentioned problems occurring in the prior art, and an object of the present invention is to provide a superconductive coil assembly having an improved structure capable of stably and continuously maintaining a cryogenic state by forming an optimized heat transfer path along the coil in conduction cooling through the provision of an electrically insulated heat transfer plate to the opposite sides of the coil.

In order to accomplish the above object, there is provided a superconductive coil assembly comprising: a bobbin; a coil provided such that a superconductive wire is wound several times around the bobbin; and a pair of heat transfer plates installed to cover the opposite sides of the bobbin and the coil and having thermal conductivity.

If adapted to a generator, an electric motor, and so on, the plurality of superconductive coil assemblies can be used while being overlapped. In this case, a connection recess may be provided to at least one heat transfer plate to enable a portion of the side of the coil to be exposed outside the plate, in order for electrical connection with another superconductive coil assembly.

The heat transfer plate may be made of metal material with high thermal conductivity, and a portion thereof abutted upon the side of the coil may be coated with electric insulating material. The heat transfer plate may be bonded to the bobbin and the side of the coil by means of an epoxy bonding or a welding.

In another embodiment of the present invention, there is provided a superconductive coil assembly comprising: a pair of bobbins disposed in parallel; a pair of coils each provided such that a superconductive wire is wound several times around each bobbin; an intermediate heat transfer plate positioned between the bobbins and having thermal conductivity; and a pair of outer heat transfer plates installed to cover the outer opposite sides of the bobbins and the coils and having thermal conductivity.

In this case, a connection recess may be provided to at least one outer heat transfer plate to enable a portion of the side of the coil to be exposed outside the plate, in order for electrical connection with another superconductive coil assembly.

The outer heat transfer plates and the intermediate heat transfer plate may be made of metal material with high thermal conductivity, and a portion thereof abutted upon the side of the coil may be coated with electric insulating material.

The intermediate heat transfer plate may have a slit through which, after wound around any one of the bobbins, the superconductive wire passes so as to be continuously wound around the other bobbin.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a superconductive coil assembly according to an embodiment of the present invention;

FIG. 2 is a perspective view of the superconductive coil assembly of FIG. 1 in assembled state;

FIG. 3 is an exploded perspective view of a superconductive coil assembly according to another embodiment of the present invention; and

FIG. 4 is a perspective view of the superconductive coil assembly of FIG. 3 in assembled state.

### DETAILED DESCRIPTION OF THE PREFERRED EMBODIMENTS

Hereinafter, preferred embodiments of the present invention will be described with reference to the accompanying drawings.

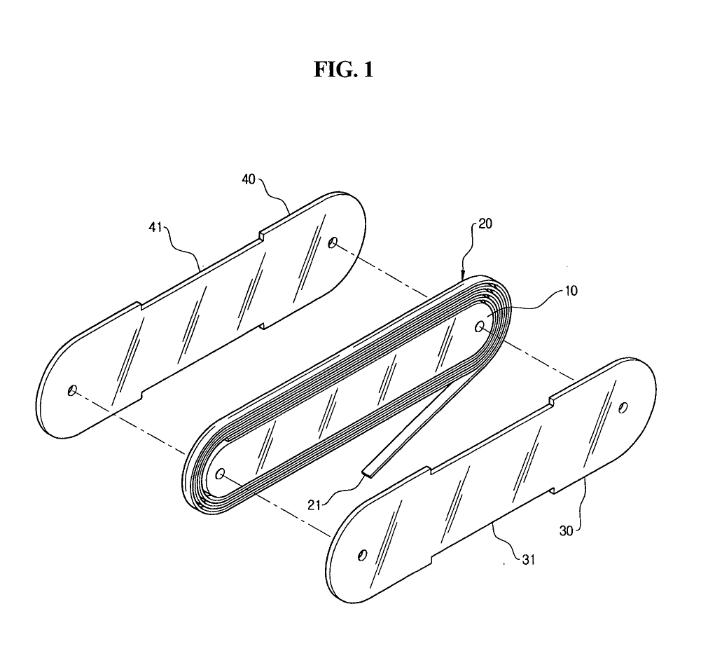

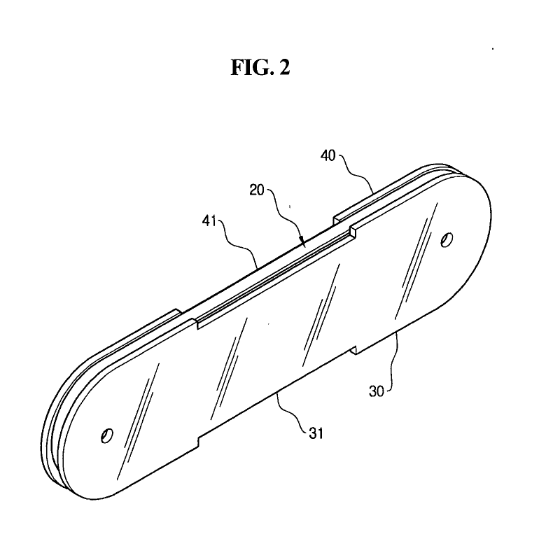

FIG. 1 is an exploded perspective view of a superconductive coil assembly according to an embodiment of the present invention, and FIG. 2 is a perspective view of the superconductive coil assembly of FIG. 1 in assembled state.

The superconductive coil assembly of the present embodiment is so-called “single pan cake” type coil assembly. As shown in FIG. 1, the superconductive coil assembly includes a bobbin 10, a coil 20 formed by winding a superconductive wire 21 several times around the bobbin 10, and a pair of heat transfer plates 30 and 40 installed to cover both the sides of the bobbin 10 and the coil 20.

The superconductive wire 21 is rectangular in cross section unlike a normal conductor so as to prevent the degradation in superconducting performance even upon application of an external shock or an excessive physical force, because other shape is likely to be damaged so that superconductive materials squeezed therein are damaged to deteriorate the superconducting performance.

Similarly, the bobbin 10 is shaped like an athletic track having a linear lane and a curved lane, so as to prevent the wire 21 from being excessively curved upon winding of the wire. The bobbin 10 has the same width as the wire 21. As the wire 21 is wound around the bobbin 10, the coil 20 becomes to be the track in shape like the outer contour of the bobbin 10.

The heat transfer plates 30 and 40 have an area covering overall sides of the bobbin 10 and the coil 20, and each has a shape of athletic track like the bobbin 10 and the coil 20. The heat transfer plates 30 and 40 are made of metal with high thermal conductivity, such as cupper or aluminum. The heat transfer plates 30 and 40 are bonded to both the sides of the bobbin 10 by means of an epoxy bonding or a welding. The coil 20 is formed by winding the wire 21 around the bobbin 10 after the bobbin 10 and the heat transfer plates 20 and 30 are assembled together. The portions of the heat transfer plates 30 and 40, each abutted upon the coil 20, i.e., the areas thereof other than the areas that correspond to the bobbin 10, are coated with electric insulating material such as Nomax® sheet or Kapton® sheet.

In case of applying the superconductive coil assembly to a generator, an electric motor and so on, the plurality of superconductive coil assemblies is used while being overlapped. In this case, it requires that the coils 20 of the superconductive coil assemblies are electrically connected with each other. The electric connection between the coils 20 is performed in such a way that a separate superconductive wire of proper length is connected and bonded to the respective coils 20. Unlike the normal conductor, the superconductive wire requires a special bonding technology such as brazing.

For electric connection with another superconductive coil assembly, the heat transfer plates 30 and 40 are provided with connection recesses 31 and 41, respectively, of proper length at opposite linear portions thereof. As shown in FIG. 2, when the superconductive coil assembly is assembled, a portion of the coil 20 is exposed outside through the connection recesses 31 and 41. A separate superconductive wire is brazed between the exposed portion of the coil 20 of one coil assembly and another exposed portion of the coil of another coil assembly, thereby possibly forming the electric connection between the coil assemblies. At this time, the connection recesses 31 and 41 prevents the superconductive wire connecting the coils 20 together from being interfered by the heat transfer plates 30 and 40, and prevents the electric connection between the coil 20 and the heat transfer plates 30 and 40 due to the flowing of fused filler metal between the coil and the plates upon brazing. Although the present embodiment has been illustrated such that the connection recesses 31 and 41 have been formed at all opposite linear portions of the heat transfer plates 30 and 40, they may be formed at any one of the heat transfer plates 30 and 40, or at any one end-side linear portion of the heat transfer plate 30 or 40.

In such superconductive coil assembly, if a cooling source (not shown) such as the evaporator of an refrigerator is abutted upon the one end-side of the coil 20 or heat transfer plates 30 and 40, cold air from the cooling source can be conducted perpendicular to the bobbin 10 along the side of the coil 20 through the heat transfer plates 30 and 40, as well as parallel (horizontal direction) to the bobbin 10. Like this, the heat transfer path between the cooling source and the coil 20 is diversified so that the cryogenic cooling of the coil 20 can be obtained fast, and the temperature gradient between the outside and inside of the coil 20 can be reduced.

In addition, the superconductive coil assembly of the invention becomes to have sufficient structural rigidity because the heat transfer plates 30 and 40 protect the side of the coil 20. Accordingly, even though the superconductive coil assembly is applied to the inside of the rotor of a generator or an electric motor, and operates under a centrifugal force, it is possible to operate the coil assembly stably and continuously.

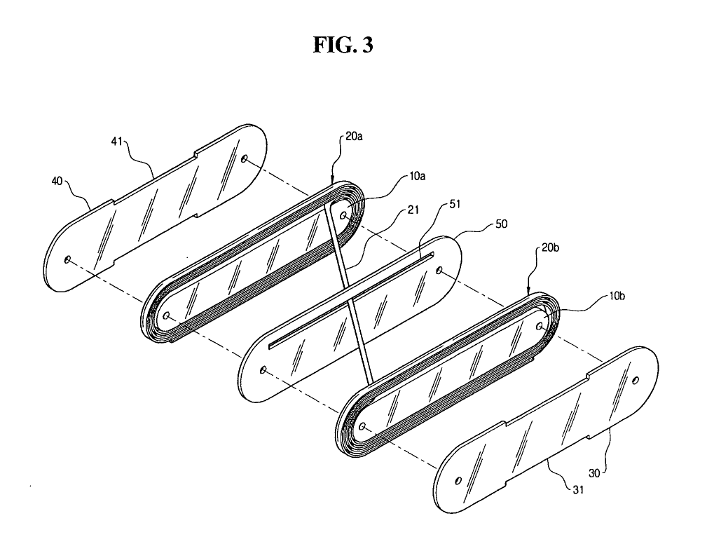

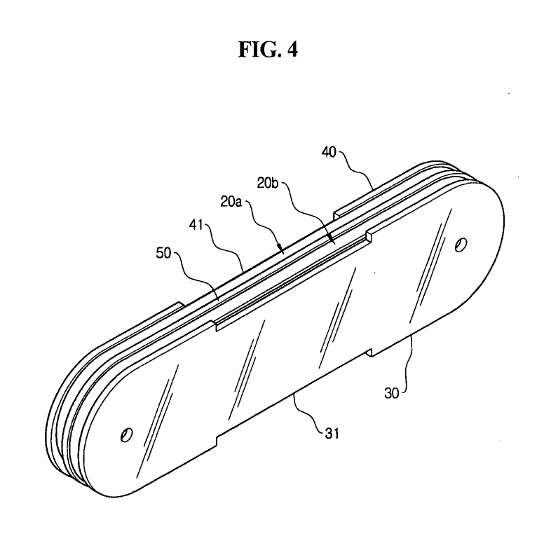

FIG. 3 is an exploded perspective view of a superconductive coil assembly according to another embodiment of the present invention, and FIG. 4 is a perspective view of the superconductive coil assembly of FIG. 3 in assembled state.

The superconductive coil assembly of the embodiment of FIGS. 3 and 4 is so-called “double pan cake” type coil assembly having a structure in which the two superconductive coil assemblies of FIG. 1 are overlapped to each other. As shown in FIG. 3, the superconductive coil assembly of this embodiment includes a pair of bobbins 10a and 10b, a pair of coils 20a and 20b each provided such that a superconductive wire is wound several times around each bobbin 10a and 10b, an intermediate heat transfer plate 50 positioned between the bobbins 10a and 10b, and a pair of outer heat transfer plates 30 and 40 installed to cover the sides of the bobbins 10a and 10b and the coils 20a and 20b.

Similar to the embodiment of FIG. 1, the outer heat transfer plates 30 and 40 and the intermediate heat transfer plate 50 have the portions that are abutted upon the coils 20a and 20b, the portions being coated with electric insulating metal. In addition, the connection recesses 31 and 41 are formed at the opposite linear portions of the outer heat transfer plates 30 and 40 for the electric connection with another superconductive coil assembly.

The bobbins 10a and 10b and the heat transfer plates 30, 40, and 50 are assembled to each other by means of an epoxy bonding or a welding. After the assembly, the superconductive wire 21 is wound around the bobbins 10a and 10b to form the coils 20a and 20b, thereby completing the superconductive coil assembly as shown in FIG. 4.

Upon winding, the superconductive wire 21 is continuously wound around the pair of bobbins one by one so that coils 20a and 20b can be electrically connected with each other. To this end, the intermediate heat transfer plate 50 has an elongated slit 51 through which the superconductive wire passes. The superconductive wire 21 is wound around one bobbin 10a, and then continuously wound around another bobbin 10b, passing through the slit 51 of the heat transfer plate 50.

Other constructions and operation of the superconductive coil assembly according to this embodiment are the same as those of the embodiment of FIG. 1 so the detailed description thereof will be omitted.

As set forth before, according to a superconductive coil assembly of the present invention, a heat transfer path between a cooling source and a superconductive coil is diversified by a heat transfer plate, thereby shortening a cooling time of the superconductive coil as well as improving cryogenic operation stability.

Further, the heat transfer plate protects the side of the superconductive coil so that even when the superconductive coil is applied to the inside of the rotor of a generator or an electric motor, and operates under the centrifugal force, it can operate stably and continuously.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A superconductive coil assembly comprising:
a bobbin;
a coil provided such that a superconductive wire is wound several times around the bobbin; and
a pair of heat transfer plates installed to cover the opposite sides of the bobbin and the coil and having thermal conductivity,
wherein a connection recess is provided to at least one heat transfer plate to enable a portion of the side of the coil to be exposed outside the plate, in order for electrical connection with another superconductive coil assembly.

2. (canceled)

3. The superconductive coil assembly as claimed in claim 1, wherein the heat transfer plate is made of metal material with high thermal conductivity, and a portion thereof abutted upon the side of the coil is coated with electric insulating material.

4. The superconductive coil assembly as claimed in claim 3, wherein the heat transfer plate is bonded to the side of the bobbin by means of an epoxy bonding or a welding.

5. A superconductive coil assembly comprising:
a pair of bobbins disposed in parallel;
a pair of coils each provided such that a superconductive wire is wound several times around each bobbin;
an intermediate heat transfer plate positioned between the bobbins and having thermal conductivity; and
a pair of outer heat transfer plates installed to cover the outer opposite sides of the bobbins and the coils and having thermal conductivity,
wherein a connection recess is provided to at least one outer heat transfer plate to enable a portion of the side of the coil to be exposed outside the plate, in order for electrical connection with another superconductive coil assembly.

6. (canceled)

7. The superconductive coil assembly as claimed in claim 5, wherein the outer heat transfer plates and the intermediate heat transfer plate are made of metal material with high thermal conductivity, and a portion thereof abutted upon the side of the coil is coated with electric insulating material.

8. The superconductive coil assembly as claimed in claim 5, wherein the intermediate heat transfer plate has a slit through which, after wound around any one of the bobbins, the superconductive wire passes so as to be continuously wound around the other bobbin.
